(19) United States
(12) Patent Application Publication
(10) Pub. No.: US 2019/0138839 A1
(43) Pub. Date: May 9, 2019

(54) IMAGE PROCESSING APPARATUS, IMAGE PROCESSING METHOD, AND PROGRAM

(71) Applicant: DENSO CORPORATION, Kariya-city, Aichi-pref. (JP)

(72) Inventors: Shuichi SHIMIZU, Kariya-city, Aichi-pref. (JP); Shusaku SHIGEMURA, Kariya-city, Aichi-pref. (JP)

(21) Appl. No.: 16/096,172

(22) PCT Filed: Apr. 25, 2017
(86) PCT No.: PCT/JP2017/016365

§ 371 Date: Oct. 24, 2018

(30) Foreign Application Priority Data
Apr. 26, 2016 (JP) 2016-088203

(51) Int. Cl. G06K 9/46; H04N 5/265; H04N 5/262; G06K 9/00; G06K 9/03

(52) U.S. Cl. CPC G06K 9/4661; H04N 5/265; H04N 5/247; G06K 9/00798; G06K 9/036; H04N 5/2628

(57) ABSTRACT

An image processing apparatus includes an image acquisition unit and a determination unit. The image acquisition unit uses a camera to acquire a first image representing an area in a first relative position and a second image representing an area in a second relative position closer to the moving direction of the vehicle than the first relative position. The determination unit compares the first image with the second image acquired earlier than the first image and representing an area overlapping the first image for luminance and/or the intensity of a predetermined color component to determine whether there exists a specific area higher in luminance than the surroundings or lower in luminance than the surroundings in the first image.

### CROSS-REFERENCE TO RELATED APPLICATION

This international patent application is to claim priority based on Japanese Patent Application No. 2016-088203, filed on Apr. 26, 2016, in the Japan Patent Office, and the entire disclosure of Japanese Patent Application No. 2016-088203 is hereby incorporated by reference.

### TECHNICAL FIELD

The present disclosure relates to an image processing apparatus, an image processing method, and a program.

### BACKGROUND ART

There have been known techniques for acquiring images of areas around a vehicle by an in-vehicle camera and performing various processes using the images. For example, there is known a technique for recognizing lane markers from the acquired images.

Further, there is also known image processing as described below. First, an in-vehicle camera is used to acquire a plurality of images of areas around the vehicle at different times. Then, the plurality of images are converted into bird's-eye view images, and the plurality of bird's-eye view images are combined to generate a combine image. Such an image process is disclosed in PTL 1.

### CITATION LIST

### Patent Literature

[PTL 1] Japanese Patent No. 4156214

### SUMMARY OF THE INVENTION

As a result of detailed examination, the inventor has found the following issues. The images acquired by an in-vehicle camera may include an area lower in luminance than the surroundings or an area higher in luminance than the surroundings. The area lower in luminance than the surroundings is an area in the shadow of a vehicle, for example. The area higher in luminance than the surroundings is an area irradiated with illumination light from headlights or the like, for example. When the images acquired by the in-vehicle camera include an area lower in luminance than the surroundings or an area higher in luminance than the surroundings, image processing may not be performed appropriately.

An aspect of the present disclosure is to provide an image processing apparatus that can determine whether there exists an area lower in luminance than the surroundings or an area higher in luminance than the surroundings in an image acquired by a camera, an image processing method, and a program.

An image processing apparatus in an aspect of the present disclosure includes: an image acquisition unit that uses at least one camera installed in a vehicle to acquire a first image representing an area in a first relative position to the vehicle and a second image representing an area in a second relative position closer to the moving direction of the vehicle than the first relative position; and a determination unit that compares the first image with the second image acquired earlier than the first image and representing an area overlapping the first image for luminance and/or the intensity of a predetermined color component to determine whether there exists a specific area higher in luminance than the surroundings or lower in luminance than the surroundings in the first image.

According to the image processing apparatus in this aspect of the present disclosure, it is possible to determine easily whether there exists a specific area higher in luminance than the surroundings or lower in luminance than the surroundings in the first image.

An image processing method in another aspect of the present disclosure includes: using at least one camera installed in a vehicle to acquire a first image representing an area in a first relative position to the vehicle and a second image representing an area in a second relative position closer to the moving direction of the vehicle than the first relative position; and comparing the first image with the second image acquired earlier than the first image and representing an area overlapping the first image for luminance and/or the intensity of a predetermined color component to determine whether there exists a specific area higher in luminance than the surroundings or lower in luminance than the surroundings in the first image.

According to the image processing method in the other aspect of the present disclosure, it is possible to determine easily whether there exists a specific area higher in luminance than the surroundings or lower in luminance than the surroundings in the first image.

Reference signs in parentheses in the claims indicate correspondences with specific units in an embodiment described later as an aspect and do not limit the technical scope of the present disclosure.

### BRIEF DESCRIPTION OF THE DRAWINGS

FIG. 1 is a block diagram illustrating a configuration of an image processing apparatus;

FIG. 2 is a block diagram illustrating a functional configuration of the image processing apparatus;

FIG. 3 is an explanatory diagram illustrating positional relationships among a front camera, a rear camera, a first relative position, and a second relative position;

FIG. 4 is a flowchart of image processing repeatedly executed by the image processing apparatus at specific time intervals;

FIG. 5 is an explanatory diagram illustrating positional relationships among a subject vehicle, the first relative position, the second relative position, a first image, and a second image;

FIG. 6 is an explanatory diagram illustrating positional relationships among the subject vehicle, the first relative position, the second relative position, the first image, the second image, and a second combine image;

FIG. 7 is an explanatory diagram illustrating positional relationships among the subject vehicle, the first relative position, the second relative position, the first image, the second image, and a first combine image;

FIG. 8 is a block diagram illustrating a configuration of an image processing apparatus;

FIG. 9 is a block diagram illustrating a functional configuration of the image processing apparatus;

FIG. 10 is a flowchart of image processing repeatedly executed by the image processing apparatus at specific time intervals;

FIG. 11 is an explanatory diagram illustrating positional relationships among a subject vehicle, a second relative position, a second image, and a bird's-eye view image;

FIG. 12 is an explanatory diagram illustrating positional relationships among the subject vehicle, the second relative position, the second image, and a second combine image;

FIG. 13 is a block diagram illustrating a functional configuration of an image processing apparatus; and

FIG. 14 is a flowchart of image processing repeatedly executed by the image processing apparatus at specific time intervals.

### DESCRIPTION OF EMBODIMENTS

Embodiments of the present disclosure will be described with reference to the drawings.

### First Embodiment

1. Configuration of an Image Processing Apparatus 1

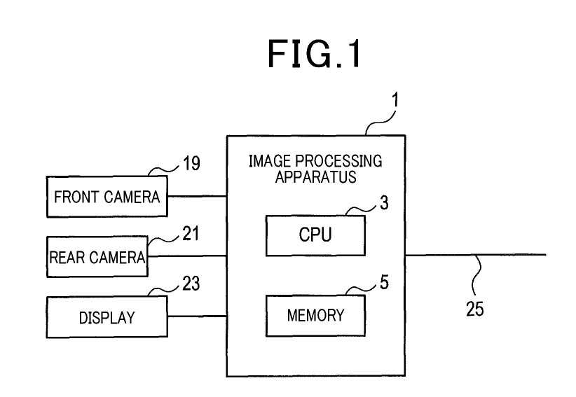

A configuration of an image processing apparatus 1 will be described with reference to FIGS. 1 to 3. The image processing apparatus 1 is an in-vehicle apparatus installed in a vehicle. The vehicle equipped with the image processing apparatus 1 will be hereinafter referred to as a subject vehicle. The image processing apparatus 1 is mainly formed of a known microcomputer having a CPU 3 and a semiconductor memory such as a RAM, a ROM, or a flash memory (hereinafter, referred to as a memory 5). Various functions of the image processing apparatus 1 are implemented by the CPU 3 executing programs stored in a non-transitory tangible recording medium. In this example, the memory 5 is equivalent to the non-transitory tangible recording medium storing the programs. When any of the programs is executed, a method corresponding to the program is executed. The image processing apparatus 1 may be formed from one or more microcomputers.

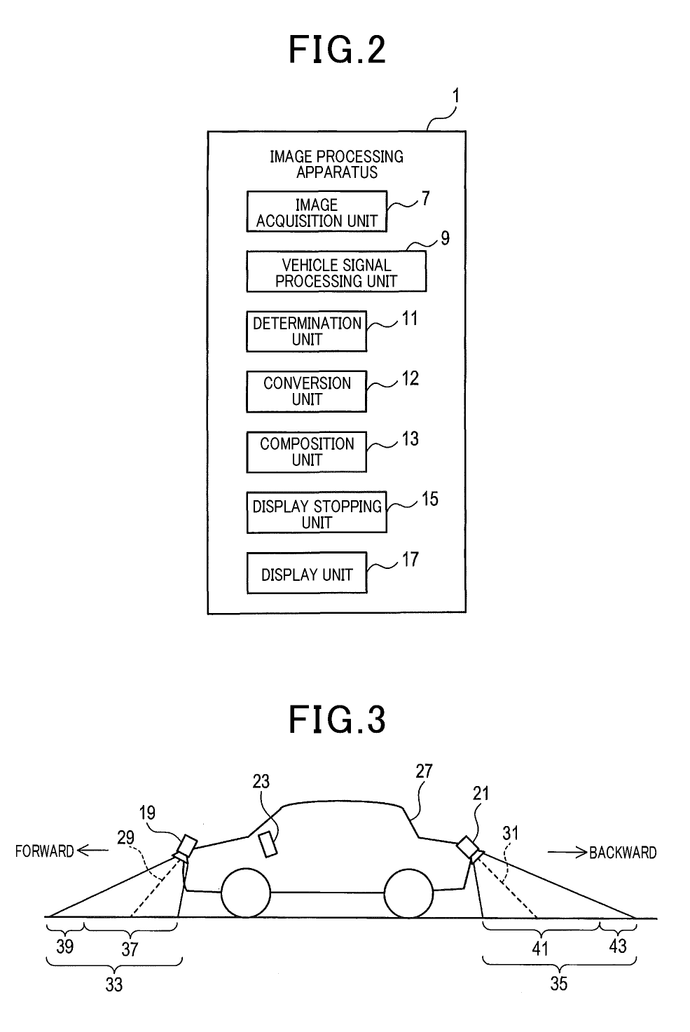

The image processing apparatus 1 includes an image acquisition unit 7, a vehicle signal processing unit 9, a determination unit 11, a conversion unit 12, a composition unit 13, a display stopping unit 15, and a display unit 17 as functional components implemented by the CPU 3 executing the programs as illustrated in FIG. 2. The method for implementing these elements constituting the image processing apparatus 1 is not limited to software but some or all of the elements may be implemented by using hardware with a combination of logical circuits, analog circuits, and others.

In addition to the image processing apparatus 1, the subject vehicle includes a front camera 19, a rear camera 21, a display 23, and an in-vehicle network 25. As illustrated in FIG. 3, the front camera 19 is installed in the front part of the subject vehicle 27. The front camera 19 acquires the scenery in front of the subject vehicle 27 to generate an image. The rear camera 21 is installed in the rear part of the subject vehicle 27. The rear camera 21 acquires the scenery behind the subject vehicle 27 to generate an image.

When the subject vehicle 27 is seen from the above, an optical axis 29 of the front camera 19 and an optical axis 31 of the rear camera 21 are parallel to the longitudinal axis of the subject vehicle 27. Each of the optical axis 29 and the optical axis 31 has a depression angle. With respect to the subject vehicle 27, the optical axis 29 and the optical axis 31 are constant at any time. Accordingly, when the subject vehicle 27 is not inclined and the road is flat, a region 33 included in the image acquired by the front camera 19 and a region 35 included in the image acquired by the rear camera 21 are always in constant positions with respect to the subject vehicle 27. The regions 33 and 35 include road surfaces.

In the region 33, a position close to the subject vehicle 27 is set to a first relative position 37, and a position more distant from the subject vehicle 27 than the first relative position 37 is set to a second relative position 39. When the subject vehicle 27 is moving forward, the second relative position 39 is located closer to the moving direction than the first relative position 37 is. The first relative position 37 and the second relative position 39 have specific sizes respectively.

In the region 35, a position close to the subject vehicle 27 is set to a first relative position 41, and a position more distant from the subject vehicle 27 than the first relative position 41 is set to a second relative position 43. When the subject vehicle 27 is moving backward, the second relative position 43 is located closer to the moving direction than the first relative position 41 is. The first relative position 41 and the second relative position 43 have specific sizes respectively.

The display 23 is provided in a cabin of the subject vehicle 27 as illustrated in FIG. 3. A driver of the subject vehicle 27 may be able to see the display 23. The display 23 displays images under control of the image processing apparatus 1.

The in-vehicle network 25 is connected to the image processing apparatus 1. The image processing apparatus 1 can acquire a vehicle signal indicating the behavior of the subject vehicle from the in-vehicle network 25. The vehicle signal is specifically a signal indicating the speed of the subject vehicle. The in-vehicle network 25 may be CAN (registered trademark), for example.

2. Image Processing Executed by the Image Processing Apparatus 1

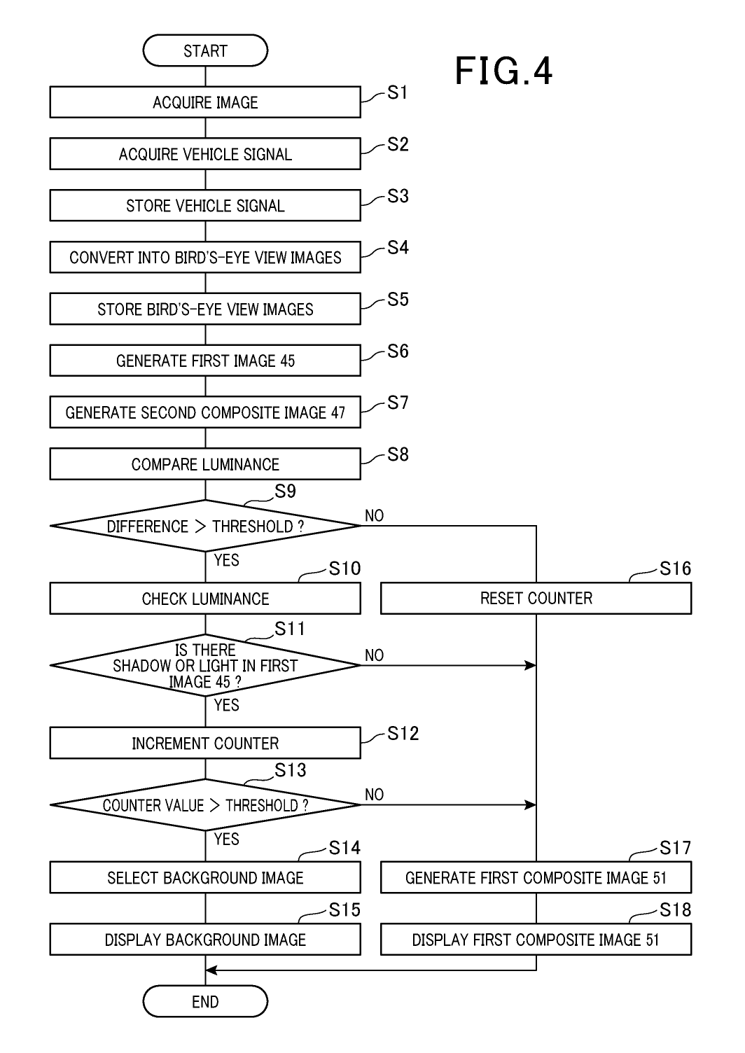

Image processing repeatedly executed by the image processing apparatus 1 at predetermined intervals I will be described with reference to FIGS. 4 to 7. The unit of the interval I is hour. Hereinafter, a single execution of the process described in FIG. 4 may be called one cycle.

An example of image processing in a case where the subject vehicle is moving backward will be described here. The following description is also applicable to the image processing in a case where the subject vehicle is moving forward, except that the images acquired by the front camera 19 are used instead of the images acquired by the rear camera 21.

In step 1 of FIG. 4, the image acquisition unit 7 acquires images by using the front camera 19 and the rear camera 21.

In step 2, the vehicle signal processing unit 9 acquires a vehicle signal through the in-vehicle network 25.

In step 3, the vehicle signal processing unit 9 stores the vehicle signal acquired in step 2 in the memory 5 in association with the time of acquisition.

In step 4, the conversion unit 12 converts the images acquired in step 1 into bird's-eye view images. Any known method can be used for converting the acquired images into bird's-eye view images. As a method for converting the acquired images into bird's-eye view images, the method described in JP 10-211849 A, for example, maybe used.

In step 5, the conversion unit 12 stores the bird's-eye view images converted in step 4 in the memory 5.

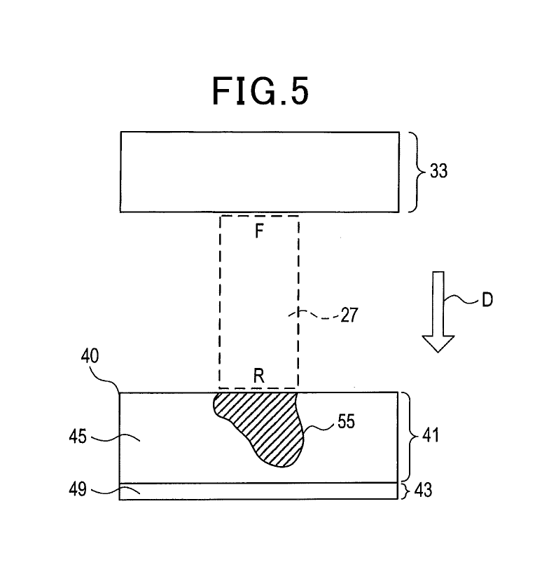

In step 6, as illustrated in FIG. 5, the image acquisition unit 7 acquires one of the bird's-eye view images 40 generated in step 4 that represents an area in the first relative position 41 (hereinafter, called a first image 45). The first image 45 is an image representing an area in the first relative position 41 at a point in time when the rear camera 21 acquired the images. A symbol D in FIG. 5 represents a moving direction of the subject vehicle 27. The moving direction D in FIG. 5 is a direction in which the subject vehicle 27 moves backward. A symbol F in FIG. 5 represents a front end of the subject vehicle 27 and a symbol R represents a rear end of the subject vehicle 27.

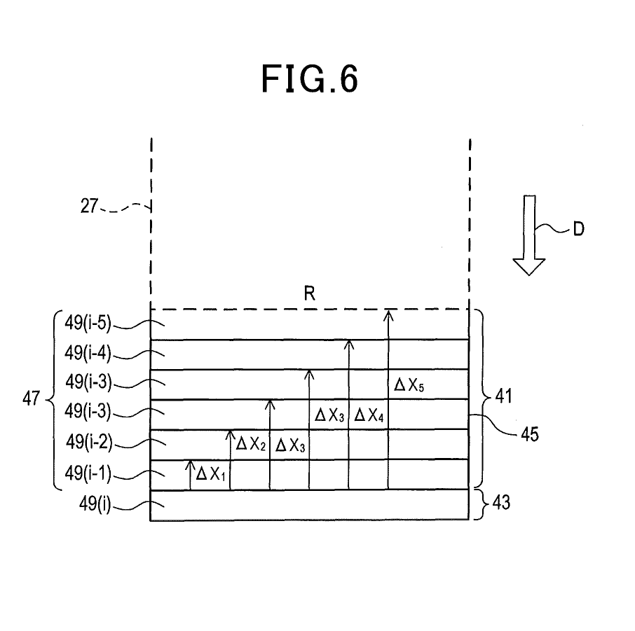

In step 7, the composition unit 13 generates a second combine image 47 illustrated in FIG. 6 by the method described below.

As illustrated in FIG. 5, some of the bird's-eye view images 40 generated in step 4 and representing the area in the second relative position 43 are set as second images 49. The second images 49 are images representing the area in the second relative position 43 at a point in time when the rear camera 21 acquired the images. In the following description, out of the second images 49, the second image generated in the current cycle will be described as 49(i) and the second images generated in the j-th cycles prior to the current cycle will be described as 49(i-j) where j is a natural number of 1 or larger.

The composition unit 13 calculates the positions of areas represented by the second images 49(i-j). The positions of the areas represented by the second images 49(i-j) are relative positions to the subject vehicle 27. The positions of the areas indicated by the second images 49(i-j) are positions shifted from the position of the area represented by the second image 49(i) by ΔXⱼ in the direction opposite to the direction D. The position of the area represented by the second image 49(i) is equal to the second relative position 43 at the present time.

The symbol ΔXⱼ represents distances by which the subject vehicle 27 has moved in the direction D from the time of generation of the second images 49(i-j) to the present time. The composition unit 13 can calculate ΔXⱼ by using the vehicle signal acquired in step 3 and stored in step 4.

Next, the composition unit 13 selects, out of the second images 49(i-j), the second images 49(i-j) that represent the areas overlapping the first image 45. In the example of FIG. 6, the second images 49(i-1) to 49(i-5) represent the areas overlapping the first image 45.

Next, the composition unit 13 combines all the selected second images 49(i-j) into the second combine image 47. The second images 49(i-j) included in the second combine image 47 are images acquired earlier than the first image 45 acquired in this cycle.

In step 8, the determination unit 11 compares the luminance of the first image 45 acquired in this cycle with the luminance of the second combine image 47 generated in step 7.

In step 9, the determination unit 11 determines whether the difference between the luminance of the first image 45 and the luminance of the second combine image 47 is greater than a preset threshold. When the difference is greater than the threshold, the determination unit 11 proceeds to step 10, and when the difference is equal to or smaller than the threshold, the determination unit 11 proceed to step 16.

In step 10, the determination unit 11 checks the first image 45 and the second combine image 47 for luminance.

In step 11, based on the results of luminance check in step 10, the determination unit 11 determines whether each of the first image 45 and the second combine image 47 has a shadow-specific or illumination light-specific feature.

The shadow-specific feature is a feature that the luminance of an area with a shadow is equal to or smaller than a preset threshold and/or the intensity of a predetermined color component is equal to or greater than a preset threshold. The illumination light-specific feature is a feature that the luminance of an area with illumination light is equal to or greater than a preset threshold.

When the first image 45 has the shade-specific or illumination light-specific feature and the second combine image 47 has no shade-specific or illumination light-specific feature, the determination unit 11 proceeds to step 12, and otherwise, the determination unit 11 proceeds to step 17.

In step 12, the determination unit 11 increments a count value by one. The count value is a value to be incremented by one in step 12 and reset to zero in step 16 as described later.

In step 13, the determination unit 11 determines whether the count value has exceeded a preset threshold. When the count value has exceeded the threshold, the determination unit 11 proceeds to step 14, and when the count value is equal to or smaller than the threshold, the determination unit 11 proceeds to step 17.

In step 14, the display stopping unit 15 selects a background image, not a first combine image described later, as an image to be displayed on the display 23. The background image is stored in advance in the memory 5.

In step 15, the display unit 17 displays the background image on the display 23. A range of display of the background image is the same as a range of display of the first combine image in step 18 described later.

When a negative determination is made in step 9, the determination unit 11 proceeds to step 16. In step 16, the determination unit 11 resets the count value to zero.

In step 17, the composition unit 13 generates the first combine image. The method for generating the first combine image is basically the same as the method for generating the second combine image 47. However, the first combine image is generated using first images 45(i-j) acquired in the past cycles, not the second images 49(i-j). The first images 45(i-j) are first images generated in the j-th cycles prior to the current cycle.

The specific method for generating the first combine image is as described below. The composition unit 13 calculates the positions of the areas represented by the first images 45(i-j). The positions of the areas represented by the first images 45(i-j) are relative positions to the subject vehicle 27. The positions of the areas represented by the first images 45(i-j) are positions shifted from the first relative position 41 by ΔXⱼ in a direction opposite to the direction D.

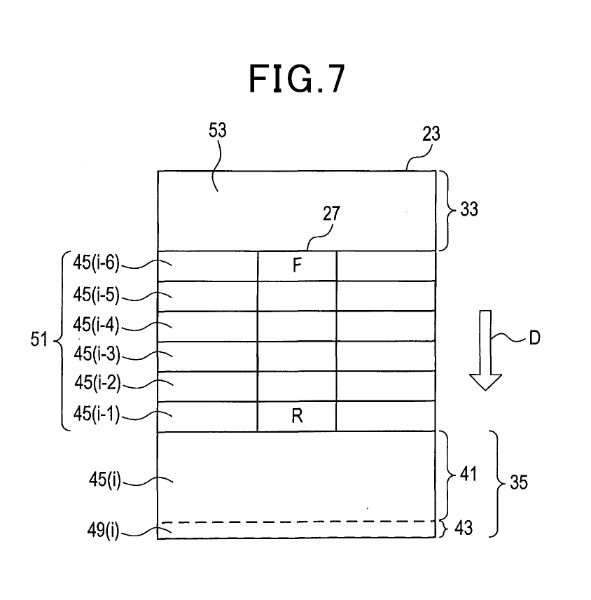

Next, the composition unit 13 selects, out of the first images 45(i-j), the first image 45(i-j) overlapping the area occupied by the subject vehicle 27. In the example of FIG. 7, the first images 45(i-1) to 45(i-6) overlap the area occupied by the subject vehicle 27.

Next, the composition unit 13 combines all the first images 45(i-j) selected as described above to generate a first combine image 51.

In step 18, the display unit 17 displays the first combine image 51 generated in step 17 on the display 23. The display area of the first combine image 51 is identical to the area occupied by the subject vehicle 27.

In the example of FIG. 7, the first image 45(i) is displayed on a lower side of the first combine image 51. The first image 45(i) is the first image 45 generated in this cycle. In the example of FIG. 7, the image acquired by the front camera 19 in this cycle is converted into a bird's-eye view image, and the converted image 53 is displayed on an upper side of the first combine image 51. In addition, in the example of FIG. 7, the subject vehicle 27 is displayed in computer graphics.

3. Advantageous Effects Produced by the Image Processing Apparatus 1

(1A) As illustrated in FIG. 5, a shadow area 55 may exist in the first image 45 representing the area in the first relative position 41. This shadow may be the shadow of the subject vehicle 27 or the shadow of any other object. The shadow area 55 corresponds to the specific area lower in luminance than the surroundings.

Even though the shadow area 55 may exist in the first image 45, the shadow area 55 is unlikely to exist in the second images 49 representing the area in the second relative position 43. In addition, the shadow area 55 is also unlikely to exist in the second combine image 47 generated by combining the second images 49.

The image processing apparatus 1 can compare the luminance of the first image 45 with the luminance of the second combine image 47 to determine easily whether the shadow area 55 exists in the first image 45.

The image processing apparatus 1 can also make a similar comparison to determine easily whether there exists an area irradiated with illumination light in the first image 45. The area irradiated with illumination light corresponds to the specific area higher in luminance than the surroundings. The illumination light is, for example, the light from the headlights of another vehicle.

(1B) The image processing apparatus 1 can generate the first combine image 51 and display the same on the display 23. However, when there exists a shadow area or an area irradiated with illumination light in the first image 45 constituting the first combine image 51, the image processing apparatus 1 stops the display of the first combine image 51. This suppresses the first combine image 51 including the shadow area or the area irradiated with illumination light from being displayed.

### Second Embodiment

1. Differences from the First Embodiment

A second embodiment is basically similar in configuration to the first embodiment. Accordingly, the same components will not be described but the differences will be mainly described. The same reference signs as those in the first embodiment represent the same components as those in the first embodiment, and thus the foregoing descriptions will be referred to here.

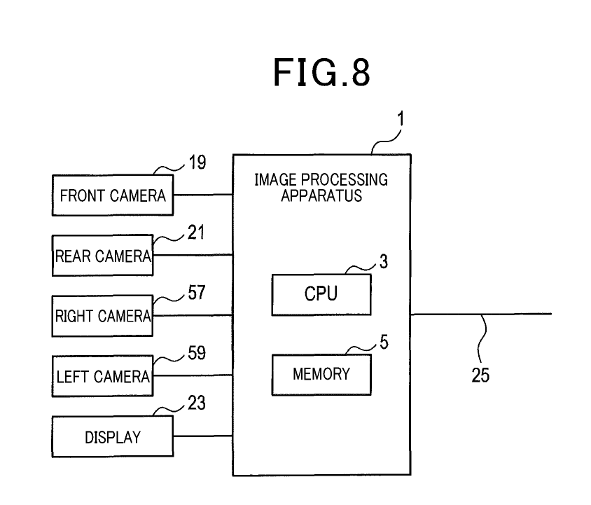

The subject vehicle includes a right camera 57 and a left camera 59 as illustrated in FIG. 8. The right camera 57 acquires a scenery on the right side of the subject vehicle to generate an image. The left camera 59 acquires a scenery on the left side of the subject vehicle to generate an image.

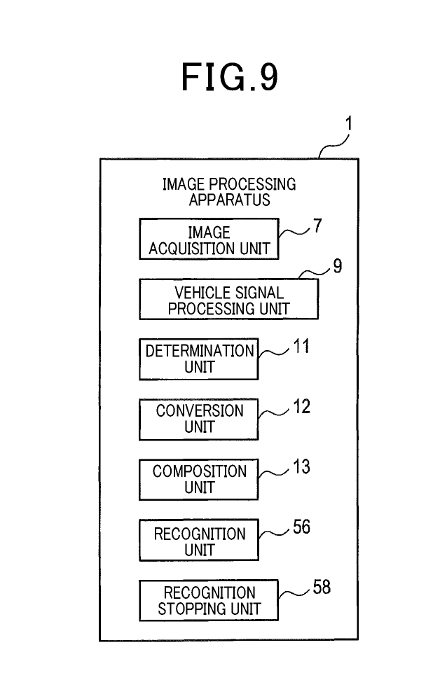

An image processing apparatus 1 includes an image acquisition unit 7, a vehicle signal processing unit 9, a determination unit 11, a conversion unit 12, a composition unit 13, a recognition unit 13, a recognition unit 56, and a recognition stopping unit 58 as illustrated in FIG. 9, as functional components implemented by the CPU 3 executing programs.

2. Process Performed by the Image Processing Apparatus 1

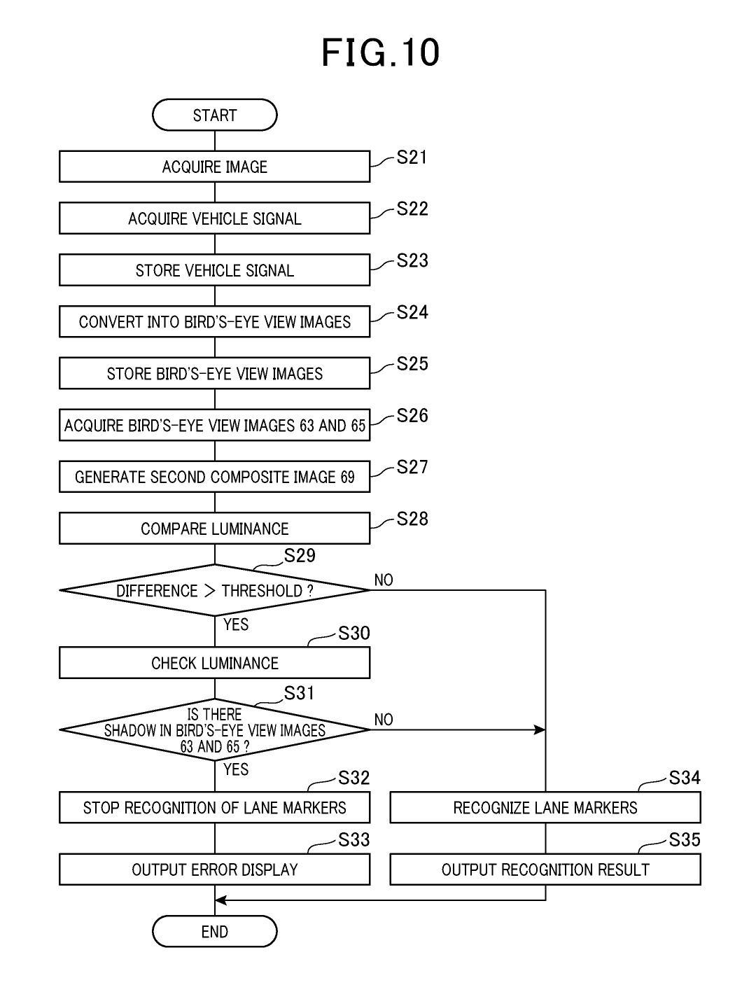

The process performed by the image processing apparatus 1 will be described with reference to FIGS. 10 to 12. In this case, the subject vehicle is moving forward as an example.

Steps 21 to 25 described in FIG. 10 are basically the same as steps 1 to 5 in the first embodiment.

In step 21, however, the image processing apparatus 1 acquires respective images from the front camera 19, the rear camera 21, the right camera 57 and the left camera 59.

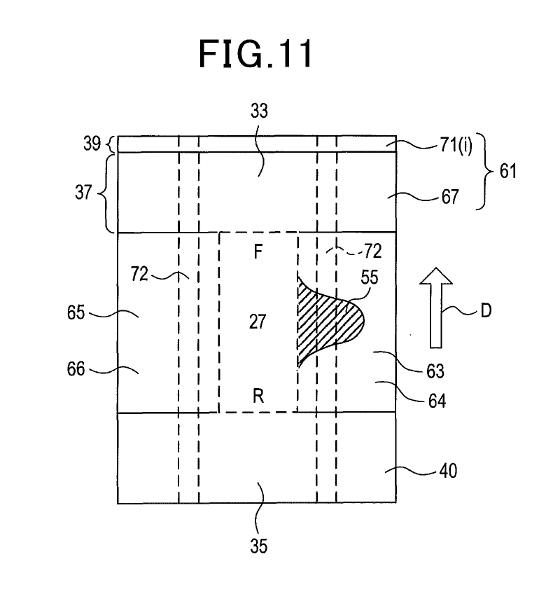

In step 24, the image processing apparatus 1 converts the images acquired from the front camera 19, the rear camera 21, the right camera 57, and the left camera 59 into bird's-eye view images. FIG. 11 illustrates a bird's-eye view image 61 converted from the image acquired by the front camera 19, a bird's-eye view image 40 converted from the image acquired by the rear camera 21, a bird's-eye view image 63 converted from the image acquired by the right camera 57, a bird's-eye view image 65 converted from the image acquired by the left camera 59.

In step 26, the image acquisition unit 7 acquires the bird's-eye view images 63 and 65 generated in step 24 by the image acquisition unit 7. The bird's-eye view images 63 and 65 correspond to first images. A relative position 64 of the bird's-eye view image 63 to the subject vehicle 27 and a relative position 66 of the bird's-eye view image 65 to the subject vehicle 27 correspond to first relative positions.

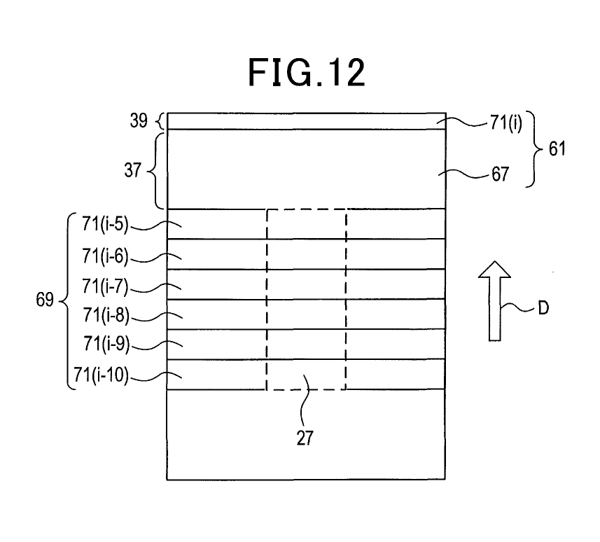

In step 27, the composition unit 13 generates a second combine image 69 illustrated in FIG. 12 by the following method.

As illustrated in FIG. 11, part of the bird's-eye view images 61 generated in step 4 and representing the area in the second relative position 39 are set as second images 71. In the following description, out of the second images 71, a second image generated in the current cycle will be designated as 71(i) and a second images generated in the j-th cycles prior to the current cycle will be designated as 71(i-j) where j is a natural number of 1 or larger.

The composition unit 13 calculates the positions of the areas represented by the second images 71(i-j). The positions of the areas represented by the second images 71(i-j) are relative positions to the subject vehicle 27. The positions of the areas represented by the second images 71(i-j) are positions shifted from the position of the area represented by the second image 71(i) by ΔXⱼ in the direction opposite to the direction D. The position of the area represented by the second image 71(i) is equal to the second relative position 39 at the present time.

The symbol ΔXⱼ represents the distances by which the subject vehicle 27 has moved in the direction D from the time of generation of the second images 71(i-j) to the present time. The composition unit 13 can calculate ΔXⱼ by using the vehicle signal acquired in step 23 and stored in step 24.

Next, the composition unit 13 selects, out of the second images 71(i-j), the second images 71(i-j) that represent the areas overlapping the bird's-eye view images 63 and 65. In the example of FIG. 12, the second images 71(i-5) to 71(i-10) represent the areas overlapping the bird's-eye view images 63 and 65. Next, the composition unit 13 combines all the second images 71(i-j) selected as described above to generate a second combine image 69.

In step 28, the determination unit 11 compares the luminance of the bird's-eye view images 63 and 65 acquired in step 26 with the luminance of the second combine image 69 generated in step 27.

In step 29, the determination unit 11 determines whether the difference between the luminance of the bird's-eye view images 63 and 65 and the luminance of the second combine image 69 is greater than a preset threshold. When the difference is greater than the threshold, the determination unit 11 proceeds to step 30, and when the difference is equal to or smaller than the threshold, the determination unit 11 proceeds to step 34.

In step 30, the determination unit 11 checks the bird's-eye view images 63 and 65 and the second combine image 69 for luminance.

In step 31, the determination unit 11 determines based on the results of luminance check in step 30 whether each of the bird's-eye view images 63 and 65 and the second combine image 69 has the shadow-specific feature. When the bird's-eye view images 63 and 65 have the shadow-specific feature and the second combine image 69 has no shadow-specific feature, the determination unit 11 proceeds to step 32, and otherwise, the determination unit 11 proceeds to step 34.

In step 32, the recognition stopping unit 58 stops the recognition of lane markers. The lane markers define a running lane. The lane markers may be white lines or the like, for example.

In step 33, the recognition stopping unit 58 provides an error display on the display 23. The error display indicates that no lane markers can be recognized.

When a negative determination is made in step 29 or step 31, the determination unit 11 proceeds to step 34. In step 34, the recognition unit 56 performs a process for recognizing the lane markers. The outline of the process is as described below. FIG. 11 illustrates an example of lane markers 72.

The determination unit 11 detects feature points in the bird's-eye view images 63 and 65. The feature points are points where a luminance change is greater than a preset threshold. The determination unit 11 then calculates approximate curves passing through the feature points. Out of the approximate curves, the determination unit 11 recognizes the approximate curves with a resemblance to lane markers equal to or greater than a predetermined threshold as lane markers.

In step 35, the recognition unit 56 outputs the results of the recognition in step 34 to other devices. The other device can use the results of lane marker recognition in a drive assist process. The drive assist process includes lane keep assist and others, for example.

3. Advantageous Effects Produced by the Image Processing Apparatus 1

According to the second embodiment described above in detail, the following advantageous effects can be obtained in addition to the advantageous effect (1A) of the first embodiment described above.

(2A) The image processing apparatus 1 stops the recognition of the lane markers 72 when the shadow area 55 exists in the bird's-eye view images 63 and 65 as illustrated in FIG. 11. This makes it possible to suppress wrong recognition of the lane markers 72 caused by the shadow area 55 from occurring.

### Third Embodiment

1. Differences from the Second Embodiment

A third embodiment is basically similar in configuration to the second embodiment. The same components will not be described but the differences will be mainly described here. The same reference signs as those in the second embodiment represent identical components and thus the foregoing descriptions will be referred to here.

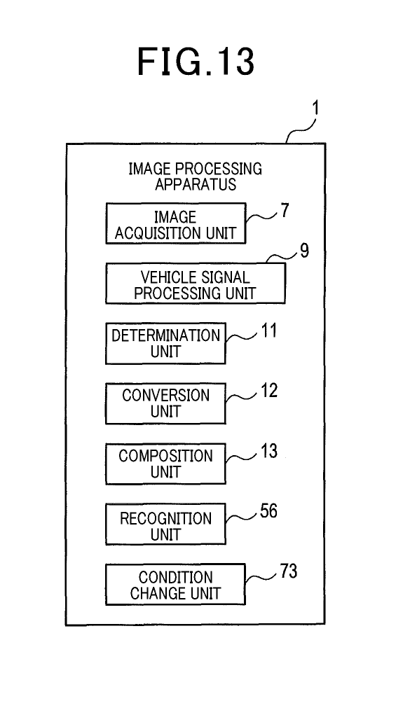

An image processing apparatus 1 includes an image acquisition unit 7, a vehicle signal processing unit 9, a determination unit 11, a conversion unit 12, a composition unit 13, a recognition unit 56, and a change condition unit 73 as illustrated in FIG. 13, as functional components implemented by the CPU 3 executing programs.

2. Process Performed by the Image Processing Apparatus 1

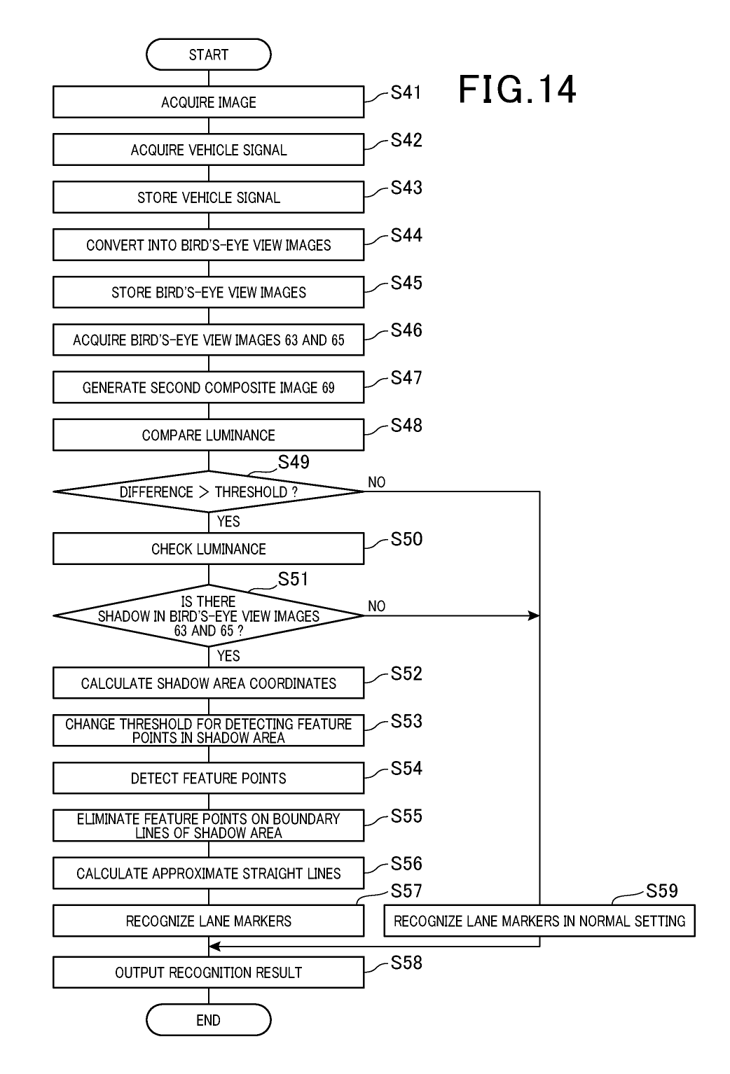

The process performed by the image processing apparatus 1 will be described with reference to FIG. 14. Steps 41 to 51 described in FIG. 14 are similar to steps 21 to 31 in the second embodiment.

In step 52, the change condition unit 73 calculates the coordinates of a shadow area in bird's-eye view images 63 and 65.

In step 53, the change condition unit 73 changes a threshold for detecting feature points in step 54 described later. Specifically, the change condition unit 73 sets the threshold for detecting feature points to be greater than a normal value in the shadow area in the bird's-eye view images 63 and 65. The threshold for detecting feature points is the normal value in the area other than the shadow area. The threshold for detecting feature points corresponds to the setting condition for recognizing the lane markers.

In step 54, the recognition unit 56 detects feature points in the bird's-eye view images 63 and 65. At this time, the value of the threshold for use in the detection of the feature points is the value changed in step 53.

In step 55, the recognition unit 56 eliminates ones of the feature points detected in step 54 that exist on the boundary lines of the shadow area.

In step 56, the recognition unit 56 calculates approximate curves passing through the feature points. The feature points for use in the calculation of the approximate curves were detected in step 54 and were not eliminated but left in step 55.

In step 57, the recognition unit 56 recognizes the approximate curves with a resemblance to lane markers equal to or greater than a predetermined threshold as a lane marker.

In step 58, the recognition unit 56 outputs the results of the recognition in step 57 or step 59 described later to other devices.

When a negative determination is made in step 49 or step 51, the process proceeds to step 59. In step 59, the recognition unit 56 recognizes the lane markers in a normal setting. The normal setting means that the threshold for use in the detection of feature points in the entire bird's-eye view images 63 and 65 is set to a normal value. In addition, the normal setting refers to a setting in which the feature points on the boundary lines of the shadow area are not excluded.

3. Advantageous Effects Produced by the Image Processing Apparatus 1

According to the third embodiment described above in detail, the following advantageous effects can be obtained in addition to the advantageous effect (1A) of the first embodiment described above.

(3A) The image processing apparatus 1 makes the setting condition for recognizing the lane markers in a case where the shadow area 55 exists in the bird's-eye view images 63 and 65 different from that in a case where the shadow area 55 does not exist. This makes it possible to suppress wrong recognition of the lane markers caused by the shadow area from occurring.

(3B) In step 53, the image processing apparatus 1 sets the threshold for detecting the feature points in the shadow area 55 to be greater than the normal value. In step 55, the image processing apparatus 1 excludes the feature points existing on the boundary lines of the shadow area 55 from the detected feature points. This makes it possible to further suppress incorrect recognition of the lane markers caused by the shadow area 55 from occurring.

### Other Embodiments

The embodiments for carrying out the present disclosure have been described so far. However, the present disclosure is not limited to the foregoing embodiments but can be carried out in various modified manners.

(1) In step 8 of the first embodiment, the luminance of the first image 45 and the luminance of the second images 49(i-j) may be compared. In addition, in step 9, it may be determined whether the difference between the luminance of the first image 45 and the luminance of the second images 49(i-j) is greater than a preset threshold.

In step 28 of the second embodiment and step 48 of the third embodiment, the luminance of the bird's-eye view images 63 and 65 and the luminance of the second images 71(i-j) may be compared. In step 29 of the second embodiment and step 49 of the third embodiment, it may be determined whether the difference between the luminance of the bird's-eye view images 63 and 65 and the luminance of the second images 71(i-j) is greater than a preset threshold.

(2) The images to be compared in step 8 of the first embodiment may be the image representing the first relative position 41 before being converted into the bird's-eye view image and the image representing the second relative position 43 before being converted into the bird's-eye view image.

The images to be compared in step 28 of the second embodiment and step 48 of the third embodiment may be the images acquired from the right camera 57 and the left camera 59 before being converted into the bird's-eye view images and the image representing the second relative position 39 before being converted into the bird's-eye view image.

(3) In step 8 of the first embodiment, the intensity of a predetermined color component CI in the first image 45 and the intensity of the same color component CI in the second combine image 47 may be compared.

In step 9, the determination unit 11 may determine whether the difference in the intensity of the color component CI between the first image 45 and the second combine image 47 is greater than a preset threshold. When the difference in the intensity of the color component CI is greater than the threshold, the determination unit 11 proceeds to step 10, and when the difference in the intensity of the color component CI is equal to or smaller than the threshold, the determination unit 11 proceeds to step 16.

In addition, also in steps 28 and 29 of the second embodiment and steps 48 and 49 of the third embodiment, the determination unit 11 may make a comparison for the intensity of the predetermined color component CI and make a determination based on the difference in the intensity of the predetermined color component CI.

The color component CI may be a blue component, or example.

(4) In step 8 of the first embodiment, the determination unit 11 may compare the first image 45 and the second combine image 47 for luminance and the intensity of the predetermined color component CI.

In step 9, the determination unit 11 may make a determination based on the differences between the first image 45 and the second combine image 47 in luminance and the intensity of the predetermined color component CI. For example, when both the difference in luminance and the difference in the intensity of the predetermined color component are greater than thresholds, the determination unit 11 can proceed to step 10, and otherwise, the determination unit 11 can proceed to step 16.

Alternatively, when either of the difference in luminance and the difference in the intensity of the color component is greater than the threshold, the determination unit 11 can proceed to step 10, and otherwise, the determination unit 11 can proceed to step 16.

Also, in steps 28 and 29 of the second embodiment and steps 48 and 49 of the third embodiment, the determination unit 11 may make both the luminance comparison and the intensity comparison of the predetermined color component CI and make a determination based on the results of the comparisons.

(5) A plurality of functions possessed by one constituent element in the foregoing embodiments may be implemented by a plurality of constituent elements, or one function possessed by one constituent element may be implemented by a plurality of constituent elements. In addition, a plurality of functions possessed by a plurality of constituent elements may be implemented by one constituent element or one function implemented by a plurality of constituent elements may be implemented by one constituent element. Some of the components in the foregoing embodiments may be omitted. At least some of the components in the foregoing embodiments may be added to or replaced by the components in other embodiments. The embodiments of the present disclosure include all aspects included in the technical ideas specified only by the description of the claims.

(6) The present disclosure can be implemented in various modes including the image processing apparatus 1, a system having the image processing apparatus 1 as a constituent element, a program for causing a computer to act as the image processing apparatus 1, a non-transitory tangible recording medium such as a semiconductor memory recording the program, an image processing method, a combine image generation method, and a lane marker recognition method.

1.-11. (canceled)

12. An image processing apparatus comprising:
an image acquisition unit that uses at least one camera installed in a vehicle to acquire a first image representing an area in a first relative position to the vehicle and a second image representing an area in a second relative position closer to a moving direction of the vehicle than the first relative position; and
a determination unit that compares the first image with the second image acquired earlier than the first image and representing an area overlapping the first image for luminance and/or intensity of a predetermined color component to determine whether there exists a specific area higher in luminance than the surroundings or lower in luminance than the surroundings in the first image, wherein
the specific area is an area with a shadow of a target object or an area irradiated with illumination light.

13. The image processing apparatus according to claim 12, further comprising:
a conversion unit that converts the first image acquired by the first image acquisition unit into a bird' s-eye view image;
a composition unit that combines the plurality of bird's-eye view images to generate a combine image;
a display unit that displays the combine image; and
a display stopping unit that stops the display of the combine image when the determination unit determines that the specific area exists in the first image.

14. The image processing apparatus according to claim 12, further comprising:
a recognition unit that recognizes a lane marker in the first image; and
a recognition stopping unit that stops the recognition of the lane marker by the recognition unit when the determination unit determines that the specific area exists in the first image.

15. The image processing apparatus according to claim 12, further comprising:
a recognition unit that recognizes a lane marker in the first image; and
a condition change unit that makes a setting condition for recognizing the lane marker by the recognition unit different between the case where the determination unit determines that the specific area does not exist in the first image and the case where the determination unit determines that the specific area exists in the first image.

16. An image processing method comprising:
using at least one camera installed in a vehicle to acquire a first image representing an area in a first relative position to the vehicle and a second image representing an area in a second relative position closer to a moving direction of the vehicle than the first relative position; and
comparing the first image with the second image acquired earlier than the first image and representing an area overlapping the first image for luminance and/or intensity of a predetermined color component to determine whether there exists a specific area higher in luminance than the surroundings or lower in luminance than the surroundings in the first image, wherein
the specific area is an area with a shadow of a target object or an area irradiated with illumination light.

17. The image processing method according to claim 16, further comprising:
converting the first image into a bird's-eye view image;
combining the plurality of bird's-eye view images to generate a combine image;
displaying the combine image; and
stopping the display of the combine image when the specific area exists in the first image.

18. The image processing method according to claim 16, further comprising:
recognizing a lane marker in the first image; and
stopping the recognition of the lane marker when the specific area exists in the first image.

19. The image processing method according to claim 16, further comprising:
recognizing a lane marker in the first image; and
making a setting condition for recognizing the lane marker different from a setting condition in the case where it is determined that the specific area does not exist in the first image when it is determined that the specific area exists in the first image.

20. A non-transitory computer-readable storage medium containing instructions for causing a computer to act as individual units in the image processing apparatus according to claim 12.
